(19) United States
(12) Patent Application Publication
(10) Pub. No.: US 2021/0391101 A1
(43) Pub. Date: Dec. 16, 2021

(54) METHOD OF PRODUCING PERMANENTLY STRUCTURED WATER

(71) Applicant: Jesper BENDSEN, Silkeborg (DK)

(72) Inventor: Jesper BENDSEN, Silkeborg (DK)

(21) Appl. No.: 17/460,702

(22) Filed: Aug. 30, 2021

Related U.S. Application Data
(63) Continuation of application No. PCT/EP2020/081047, filed on Nov. 5, 2020.

(30) Foreign Application Priority Data
Nov. 5, 2019 (DK) 201901293
Nov. 7, 2019 (DK) 201901305
May 8, 2020 (DK) 202000551

(51) Int. Cl. H01B 12/02; C02F 1/46

(52) U.S. Cl. CPC H01B 12/02; C02F 1/46; C02F 2305/00; C02F 2303/00; C02F 2301/04

(57) ABSTRACT

A method of producing permanently structured water, several products based on superconducting material, such as food, cosmetics, medicals, jewelry, cleaning and radioactivity-reducing product, and various uses of a superconducting material.

### FIELD

The present invention relates to a method of producing permanently structured water as well as several products based on superconducting material, such as food, cosmetics, medicals, jewelry, cleaning and radioactivity-reducing product. Furthermore, the present invention concerns various uses of a superconducting material.

### BACKGROUND

Structured water is water tapped from a natural spring source or water tapped from a watercourse that winds through a landscape in certain movements or water that is moved through certain flowforms that imitate the same movements that water is subject to in nature which make water structured. Structured water can be said to have had its memory erased and been reset back to its natural structure and has had its natural energy levels increased. Structured water loses its structure and energy within a short period of time when it is transported away from where it is tapped or stored. Or it loses its structure when it is exposed to energy impressions which it stores within itself.

There are many methods of producing structured water with, but with all methods known today, the structured water will stop being structured after a shorter or longer period of time depending on what the water is exposed to. This is because water has memory.

### SUMMARY

The present inventors have designed a method and device for producing structure water and permanently structured water.

One aspect in accordance with the invention concerns a method of producing permanently structured water, characterized in that water is passed through at least one flowform and superconducting materials are placed sufficiently close to where the water moves through the flowform.

One aspect in accordance with the invention concerns a method in a form of embodiment where superconducting material is selected from fluorite, modified quartz and permanently structured water.

One aspect in accordance with the invention also concerns a food product, characterized in that it comprises at least one superconducting material.

One aspect in accordance with the invention also concerns a cosmetic product, characterized in that it comprises at least one superconducting material.

One aspect in accordance with the invention also concerns a cosmetic product in a form of embodiment, characterized in that the at least one superconducting material is chosen from modified fluorite, modified quartz and permanently structured water.

One aspect in accordance with the invention also concerns a cosmetic product in a form of embodiment, characterized in that the product is chosen from among creams, deodorants, lotions etc.

One aspect in accordance with the invention also concerns a medical product, characterized in that it comprises at least one superconducting material.

One aspect in accordance with the invention also concerns a medical product in a form of embodiment, characterized in that the at least one superconducting material is chosen from modified fluorite, modified quartz and permanently structured water.

One aspect in accordance with the invention also concerns a medical product in a form of embodiment, characterized in that the product is chosen from among blood treatment products, products that changes the electrical potential of the surface of cells, skin treatment products, muscle treatment products, etc.

One aspect in accordance with the invention also concerns a jewelry product, characterized in that it comprises at least one superconducting material.

One aspect in accordance with the invention also concerns a jewelry product in a form of embodiment, characterized in that the at least one material is chosen from modified fluorite, modified quartz and permanently structured water.

One aspect in accordance with the invention also concerns a cleaning product, disinfecting product and chemical product, characterized in that it comprises at least one superconducting material.

One aspect in accordance with the invention also concerns a radioactivity-reducing product, characterized in that it comprises at least one superconducting material.

One aspect in accordance with the invention also concerns the use of superconducting materials for the manufacturing of a product chosen from the group consisting of permanently structuring water products, beverage products, food products, feed products, cosmetic products, medical products, jewelry products, cleaning products, disinfecting products, chemical products and a radioactivity reducing product.

One aspect in accordance with the invention also concerns use in a form of embodiment, characterized in that the superconducting material is chosen from modified fluorite, modified quartz and permanently structured water.

One aspect in accordance with the invention also concerns a wellness water product, characterized in that it comprises at least one superconducting material.

One aspect in accordance with the invention also concerns the use of superconducting materials for the manufacturing of a product chosen from the group consisting of wellness water products.

One aspect in accordance with the invention also concerns use in a form of embodiment, characterized in that the superconducting material is chosen from modified fluorite, modified quartz and permanently structured water.

One aspect in accordance with the invention also concerns the use of superconducting materials for increasing the shelf-life of a product consisting of permanently structuring water products, beverage products, food products, feed products, cosmetic products, medical products, jewelry products, cleaning products, disinfecting product, chemical products.

One aspect in accordance with the invention also concerns use in a form of embodiment, characterized in that the product is a drinks product.

One aspect in accordance with the invention also concerns use in a form of embodiment, characterized in that the product is a fruit and/or vegetable.

One aspect in accordance with the invention also concerns use in a form of embodiment, characterized in that the product is a feed product.

One aspect in accordance with the invention also concerns use in a form of embodiment, characterized in that the product is a cosmetic and/or a medical product.

One aspect in accordance with the invention also concerns use in a form of embodiment, characterized in that the superconducting material is chosen from modified fluorite, modified quartz and permanently structured water.

One aspect according to the invention also concerns use in a form of embodiment, characterized in that the superconducting material is chosen from among metals and/or all other conceivable materials that are made superconducting.

One aspect in accordance with the invention concerns a method of producing permanently structured water, characterized in that water is passed through at least one flowform that is a shaped like the integer 8.

One aspect in accordance with the invention concerns a method of producing permanently structured water, characterized in that water is passed through at least one flow form that is a shaped like the integer 8. One aspect according to the invention concerns a method in a form of embodiment where superconducting material is chosen from modified fluorite, modified quartz and permanently structured water.

One aspect according to the invention also concerns a method in a form of embodiment where the superconducting material is chosen from among all conceivable materials that are made superconducting.

One aspect according to the invention also concerns a method in a form of embodiment where the superconducting material is chosen from among metals and/or carbon materials, such as graphite.

One aspect according to the invention also concerns a method in a form of embodiment where the superconducting material is chosen from among crystals.

Further objects and advantages of the present invention will appear from the following description, and claims.

### DEFINITIONS

Modified fluorite is defined as being products containing fluorite (CaF₂). Modified fluorite is ordinary fluorite which is made superconducting for vacuum energy at a quantum level and brought into permanent resonance thereby. Modified fluorite can be purchased at the website https://apogi.tech/shop/superconductive-materials/

Normal fluorite is defined as being fluorite (CaF₂) which is not superconducting for vacuum energy at quantum level. Fluorite can be naturally colored as there are other substances contained in the fluorite. It can be found in nature and/or come from mines. It can also be chemically produced.

Normal structured water is defined as being water tapped from a natural spring source and/or water tapped from a watercourse that winds through a landscape in certain movements and/or patterns and/or whirls. Structured water is vitalized water that contains more energy than normal water. Structured water loses its structure and energy over time. Structured water still has memory, understood in the way that the structured water still takes up energetic effects from the surroundings. The energetic effects from the surroundings shorten the time that elapses until the structured water loses its structure. The stronger the energetic effects from the surroundings, the greater the shortening of the time until the structured water loses its structure.

Flowform is defined as an object which water runs through and/or over and which causes the water to move in certain movements and/or patterns and/or whirls that make the water into structured water. All objects which can make water structured are defined as a flowform.

Permanently structured water is defined as being structured water which remains structured for a longer time than structured water and/or exhibits greater resistance to changes in its structure than normal structured water when it is exposed to energetic effects from the surroundings. Permanently structured water is normal water which is made superconducting for vacuum energy at a quantum level and brought into permanent resonance thereby.

PSU (Permanent Structuring Unit) is defined as a machine or a construction which can produce permanently structured water. Hereinafter referred to as PSU. The machine comprises at least one flowform and comprises modified fluorite and/or other superconducting materials.

Energy is defined as being the energy given off by permanently structured water and/or superconducting material. The energy originates from vacuum energy generated at quantum level. Permanently structured water and/or a superconducting material is an amplifier and/or a superconductor of vacuum energy.

Superconducting material is defined as being a material that affects water and produces permanently structured water as described for example in “A method of producing permanently structured water”. Modified fluorite and modified quartz are a superconducting material.

Superconducting material is also defined as a material that only affects water, or a material that only produces permanently structured water.

Food/drink/irrigation products are defined as food products and drink products for humans and animals, as well as irrigation products for plants and crops.

Food products for animals can also be referred to as feed.

### BRIEF DESCRIPTION OF DRAWINGS

FIG. 1 illustrates a flowform holder which is to be filled with a liquid, such as water.

FIG. 2 illustrates a flowform according to the invention.

FIG. 3 illustrates another flowform according to the invention.

### DETAILED DESCRIPTION

Overall, the invention concerns a method in which a superconducting material is used to produce permanently structured water that can be used in food/drink/irrigation products, feed products, cosmetic products, medical products, jewelry products, cleaning products, disinfecting products, chemical products and radioactivity-reducing products

Furthermore, the invention concerns use of permanently structured water and/or a superconducting material in food/drink/irrigation products, feed products, cosmetic products, medical products, jewelry products, cleaning products, disinfecting products, chemical products and radioactivity-reducing products.

When something is made superconducting for vacuum energy at a quantum level and brought in permanent resonance thereby it means that it can continue to give off this energy to the surroundings. Vacuum energy is given off in the form of an energetic flux at a quantum level. This means that under the right conditions, electricity can be fed into a lamp, a washing machine, etc. and thus operate various electrical appliances. If the electrical conditions and the appliance into which the electricity is fed are not properly configured, the appliance will not work. In addition, electrical fields are routed in air, and electricity can thus also be transferred to other appliances without being in direct contact with them. For example, a wireless network.

In a similar way, permanently structured water and a superconducting material will be able to release energy into other materials by mixing with other materials or being sufficiently close to the other materials. In order for a meaningful transfer of energy to other materials to take place, the conditions must be right, and this also applies to electrical energy and electrical magnetic fields.

This document describes some of the applications where permanently structured water and/or a superconducting material can successfully transfer energy to other materials.

Ordinary water has memory which means it can remember energy impressions. This can be in the form of subtle energies such as thoughts and feelings. Or how a DNA strand is to be collected. Or electromagnetic smog, frequencies and noise can also be stored in the water. When ordinary water is treated to become permanently structured water, this memory is erased, and the water is brought back to a high natural energy state with no memory and impression.

Normal structured water has many of the same effects and properties as permanently structured water has. Thus, permanently structured water will have all the same effects as normal water has in general. The main difference between the two types of water is that permanently structured water permanently has the highest possible energy content of the two types. Everything else being equal, this means that there are more applications of permanently structured water and they can last for a longer time.

This section and all sub-section describe forms of embodiment and/or forms of use for all claims in the patent. Patent claims that are not specifically referred to in a sub-section may therefore be indirectly covered or implied and covered by the detailed descriptions.

### A method of Producing Permanently Structured Water

An aspect of the present invention relates to a method of producing permanently structured water, characterized in that water is passed through at least one flow form and superconducting materials are placed sufficiently close to where the water moves through the flowform. Typically, the superconducting material is selected from fluorite, modified quartz and permanently structured water.

A further aspect of the present invention concerns a method of producing permanently structured water, characterized in that water is passed through at least one flowform that is a shaped like a FIG. 8 (the integer eight). Typically, the superconducting materials are placed sufficiently close to where the water moves through the flow form so that permanently structured water is produced.

The invention will now be described more fully with reference to the appended drawings illustrating typical embodiments of the invention. These drawings are by no means limiting the scope of the present invention and are only intended to guide the skilled person for better understanding of the present invention.

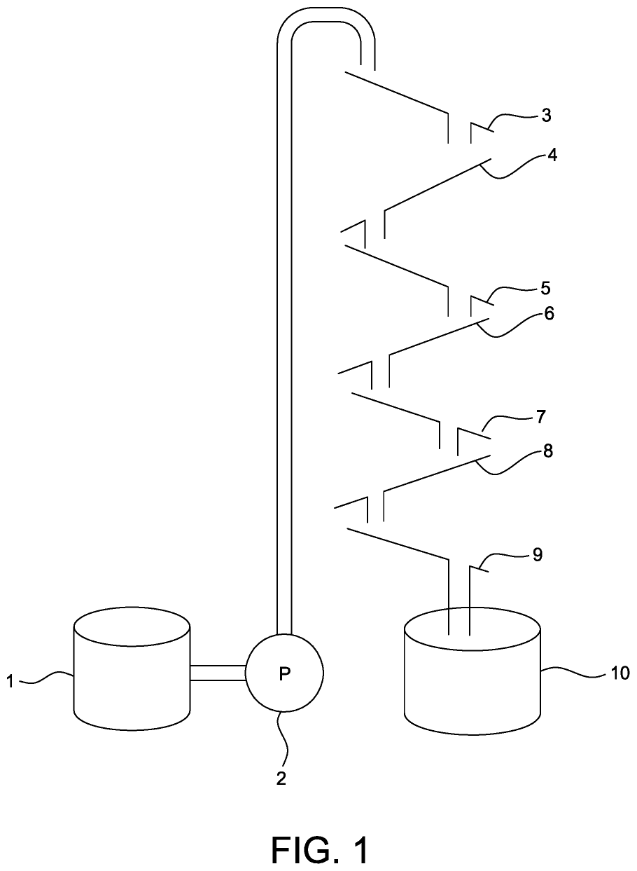

The PSU machine is shown in FIG. 1. It consists of 7 flowforms and a superconducting material located sufficiently close to the place in each individual flowform where the water is whirled most, without disturbing the whirl itself. The PSU has approximately 50 grams of a superconducting material located 1 cm from the whirl in each flowform. At least one flowform is required in the PSU. Several flowforms increase the energy in the water.

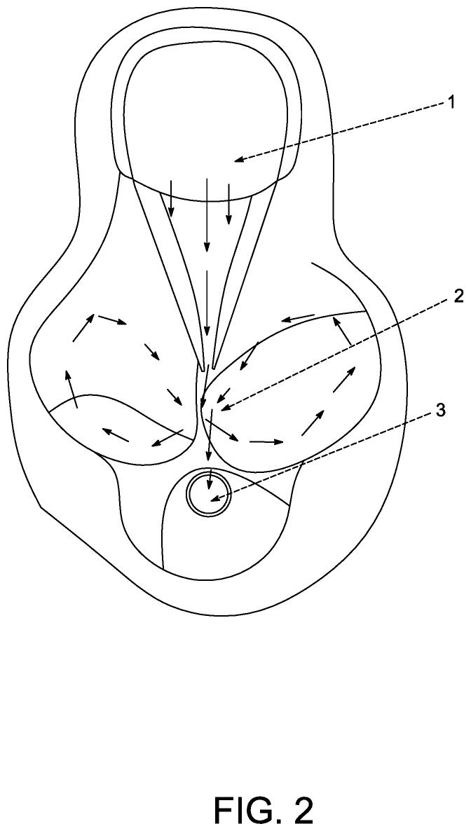

The flowforms which were used moved the water in integer 8 movements, FIG. 2, but flowforms might as well have been used that moved the water in whirls. Both kinds of flowform create whirls where the water collides with itself.

A PSU could also be constructed of a long water hose that folds in integers of 8 on top of each other where superconducting materials are located sufficiently close to the middle of all integers of 8.

The modified fluorite that is used might could just as easily be replaced by modified quartz, or other crystals which can also be modified to become a superconducting material.

The modified fluorite referred to in this document is purchased through the apogi.tech website.

### A test to Produce Permanently Structured Water

For the experiment, 7 flowforms were used that were placed vertically on top of a stand. Each flowform had an inlet at the top and an outlet at the bottom. They were placed in such a way on the stand that the water ran into the upper flowform and down through all flowforms and out at the bottom of the lowermost flowform. The flowform wall forms used in this experiment were called Glonn 80′ Polymer Skin and were purchased at www.flowform.net

The flowforms each moved the water in an integer of 8 movement. On the underside of the form of each flowform wall modified fluorite was placed in the middle of the integer of 8 movement. The product was purchased at the following website https://apogi.tech/shop/apogi-mc50d100/

FIG. 1 shows a flowform holder (1) which was filled with approximately 240 litres of water. The electric pump (2) was then started so that the water was pumped into the upper flow form (3) at a rate of approximately 80 litres of water per minute. From the top flowform, the water circulated down through the underlying flowforms (4, 5, 6, 7, 8, 9) and down to a flowform holder (10). The pump (2) operated for about 3 minutes, then it was turned off.

FIG. 2 point 1 is where the water flows into the flowform, and point 3 is where the water flows out of the flowform. Point 2 is where the modified fluorite was placed directly on the back of the flowform and where the water meets when it moves in integer of 8 movements.

### Measuring Method for Permanently Structured Water

A test is being set up where water before and after treatment is being tested by way of refractoscopy in the following wavelength range from 465 nanometres (nm) to 4000 nm. The expectation is that at around 3000 nm a change will be measured in relation to before and after.

A test is being set up where water before and after treatment is being tested by way of US-VIS-NIR-IR spectroscopy. The expectation is that at around 3000 nm a change will be measured in relation to before and after.

A test is being set up where water before and after treatment is being tested by RAMAN spectroscopy. The expectation is that at around 3000 nm a change will be measured in relation to before and after.

Tests are being set up to test whether permanently structured water can better maintain a higher oxygenation rate for longer than not permanently structured water. The expectation is that is can.

### Test 2 to Produce Permanently Structured Water with

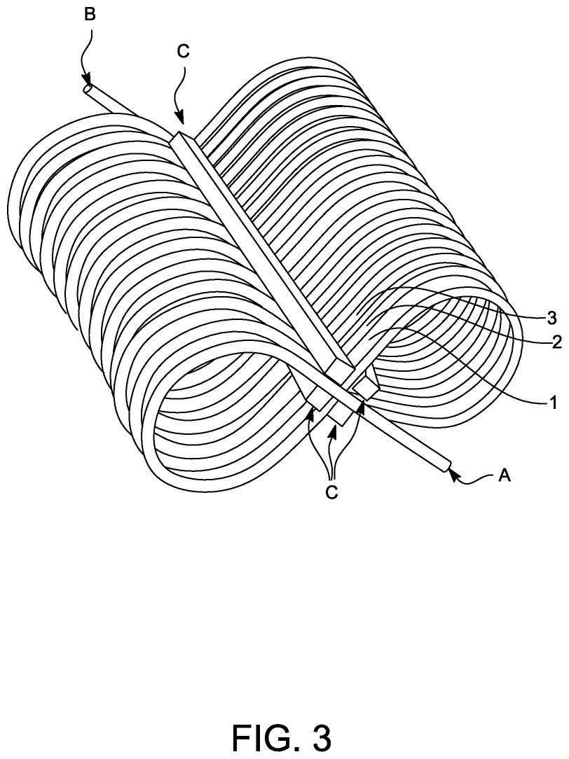

In this test, an integer of 8 flowform as shown in FIG. 3 was used. The flowform had 21 integers of 8 but had also worked if it had only had one integer of 8 flowform.

Point A is where the water flowed into the flowform. Point B is where the water flowed out of the flowform.

Point 1, 2 and 3 are where air was pumped into the flowform. Enough air was pumped into the flowform so that the oxygen saturation in the water was at least 100%. The water would still have become permanently structured water if no oxygen had been added.

Point C are the 4 elongated square tubes which contain a superconducting material which in this experiment was modified fluorite. Each tube was just as long as the integer of 8 flowform itself, and each tube contained approximately 1.5 kg of modified fluorite. The pipes were located close to the centre of each integer of 8 flowform. The modified fluorite was purchased at the following website https://apogi.tech/shop/apogi-mc50d100/

Any other superconducting material could have been used here.

The water used in this experiment was water from a reverse osmosis plant. Plain tap water could also have been used.

The end result was that the water became permanently structured water.

If the 4 square pipes, point C, had not been filled with a superconducting material, or the pipes were not present, the water coming out of point B would have been structured water, but not permanently structured water.

### Food Products and Their Uses

In a further aspect the present invention relates to a food product, characterized in that it comprises at least one superconducting material.

In a still further aspect, the present invention relates to use of superconducting materials for increasing the shelf-life of a product selected from food products.

Permanently structured water can be fully or partially incorporated into drinking water, water to irrigate crops, plants and fields, drinks in general, foods, feeds, juices, wine, beer, milk, soft drinks and alcoholic drinks.

Superconducting materials can be fully or partially incorporated into the physical environments where foods and/or feeds and/or crops are stored. The effect is that the shelf life of foods and/or feeds and/or crops is increased compared to if superconducting materials were not present and/or placed close enough to them.

### Use in Drink Products and Juices

Use can take place through mixing permanently structured water into drink products, or through the drink itself consisting solely of permanently structured water. Through the permanently structured water, all products will have better properties, which is understood to mean that what the individual products were intended to achieve is improved and/or can last longer. Thus, some drinks/foods will have a better taste and/or longer shelf life.

If permanently structured water is mixed into juices, vegetables and/or fruits will have a more intensive and better taste and for a longer time than if no permanently structured water were mixed in. The permanently structured water can make up as little as 1-5% volume of the juice. Another effect is that the juice's shelf life is extended from about 3 days to about 6 days or more, and the taste is fresh and uniform on all of the days.

### Use for Cows

In several places in Denmark, farmers have problems with the fact that their livestock will not drink the water coming from water works via the water pipe leading up to their farm. There is a strong suspicion that this may be due to electromagnetic fields, currents and voltages from high voltage power lines and/or from wind turbines and/or from frequency-controlled water pressure pumps that leave an electromagnetic signature in the water that is perceived as unpleasant for livestock. The suspicion has arisen because many of the farmers with these problems have had the current voltages measured in their drinking water.

The PSU cleans water of electromagnetic signatures and revitalises water.

We therefore tested a PSU set up on a farm with cows where it could be observed that the cows were not happy to drink the water and were below normal for the number of mincing's per day.

After 3 weeks of testing, the data showed an increase in milk production of 8.3% and an increase in the number of milking's of 7.9% due to the cows only drinking water purified with the PSU.

### Use for Plants and Crops

By using permanently structured water to water crops in agriculture, plants will always receive the necessary energy they need to be able to grow and develop optimally.

Therefore, if fruits, vegetables, water, drink or food products as a whole have room for or need more energy, they will receive this from the permanently structured water and/or a superconducting material that it comes with.

Energy is one component in interaction with proper temperature, light, water, nutrients, environment, and other factors, and permanently structured water and/or a superconducting material cannot compensate entirely if one of these other components is missing.

When foods and/or feeds and/or crops are stored sufficiently close enough to superconducting materials, their shelf life will increase.

### Test with the Shelf Life of Tomatoes

We carried out a test on organic tomatoes where we could see that in the case of the tomatoes where enough superconducting materials were present and sufficiently close to the tomatoes, the shelf life increased to such an extent that they were still edible after a period of 20-30 days. In the case of tomatoes without the influence of superconducting materials, approximately 40-50% of their mass rotted away after a period of 20-30 days. In the experiment, 15 grams of superconducting material was placed a few centimetres away from 2 organic tomatoes, referred to as set-up A. Placed 8 meters away from line A, were another 2 organic tomatoes and no superconducting material, referred to as set-up B. The 4 organic tomatoes were bought at the local supermarket in the same packaging.

After 30 days there was only a little wrinkling to see on the tomatoes at set-up A. At setup B, approximately 40-50% of the mass of tomatoes had disappeared and it was clear to see that they were rotten.

### Cosmetic Products and Their Uses

In a further aspect, the present invention relates to a cosmetic product, characterized in that it comprises at least one superconducting material. Typically, the superconducting material is selected from among fluorite, modified quartz and permanently structured water. Typically, the product is chosen from among creams, deodorants, and/or lotions.

Further aspects of the invention relate to use of superconducting materials for increasing the shelf-life of a product selected from cosmetic products.

When permanently structured water and/or superconducting materials are mixed into creams, the skin and skin cells will receive energy at a quantum level that ends up building up the electrical potential on the surface of cells and/or energy level of cells in general.

Cosmetic products will have a better effect and/or longer shelf life and/or provide energy to the user.

### Use in Cosmetics

10 containers of ordinary L'Oréal 50 ml day cream were purchased which were mixed with 5 grams of powdered modified fluorite in each cream. This is equivalent to 10% modified fluorite. It was then applied to the face in a normal layer in 10 subjects.

The perception of the test subjects was that they gained more energy, felt more awake, had more vitality and energy, and had more colour and blood flow in the face.

Several of the test subjects had mosquito bites that itched, and when they applied the cream, they found that the mosquito bites stings stopped itching.

Several of the subjects had small scratches and wounds; they applied the cream over a few days and experienced that scratches and wounds healed faster than normal.

We tried several different concentrations of modified fluorite in the creams. If there was over 20% of modified fluorite therein, some subjects might find that they became more emotional and were more likely to express feelings. But it was also very much a question of whether the test subject himself/herself was generally a predominantly mental or emotional person.

We found that if we used between 5% and 10% modified fluorite in the cream, the subjects gained more energy, felt more awake, had more vitality and energy, and had more colour and blood flow in the face.

### Medical Products and Their Use

In a still further aspect, the present invention relates to a medical product, characterized in that it comprises at least one superconducting material. Typically, the superconducting material is selected from among fluorite, modified quartz and permanently structured water. Typically, the product is chosen from among blood treatment products, a product that changes the electrical potential of the surface of cells, skin treatment products, muscle treatment products, etc.

In a further aspect the present invention relates to use of superconducting materials for increasing the shelf-life of a product selected from medical products.

As described above applications where modified fluorite affects blood, modified fluorite can be used to treat blood. In the study, it is apparent that the result of the effect of modified fluorite on the red blood cells is that they can now move freely between each other and no longer clump together. The modified fluorite and permanently structured water have the same properties and effects, so it is evident to assume that the permanently structured water will have the same effect whether it lies on the body or whether it is ingested orally.

We have indications that what happens is that the electrical potential on the surface on the red blood cells is recharged, which is why there is now an electrical charge that allows the red blood cells to electrically repel each other so that they can individually move freely between each other.

The effect that can be seen on the red blood cells can clearly be assumed to happen on all cells whether it is in blood or not. The right electrical potential on the surface on cells in general is essential for various nutrients, signalling agents and waste materials to pass in and out of the cell. And the permanently structured water and/or modified fluorite has the effect on cells that the electrical potential on the surface of cells is restored and/or rebuilt.

Blood treatment products improve and or/repair the cells in the blood by taking in the permanently structured water orally, intravenously or applying it to the skin.

Skin and/or wound treatment products provide more energy to the skin and/or restore healthy skin and/or heal the skin faster than if the product is not used. See “Uses where modified fluorite heals wounds”.

Because the technology builds up the electrical potential on the surface on cells in general, the functioning of cells generally improves for the better. It is therefore to be expected that stress on the body at a macro level will be reduced. This means that it is expected that if stress blood markers are measured it will be seen that they have become lower.

### Uses where Modified Fluorite Affects Blood

A test subject came to the Holmes Health clinic in LA. She had a drop of blood collected here and blood microscopy was performed on the drop of blood. Under the microscope it could be seen that many of her red blood cells had clumped together.

She then had approximately 15 grams of modified fluorite place on the top of her head, on her forehead, on her neck, chest, on the solar plexus, on the abdomen and at the end of the lower part of the spine. She lay on her back for around 15 minutes. All in all, approximately 105 grams of modified fluorite. She neither drank, ate or went to the toilet.

She then had another drop of blood taken, and the same blood microscopy was performed again.

The result was that all her red blood cells were now not lumped together but moved quickly and freely between each other.

### Uses where Modified Fluorite Heals Wounds

One test subject had had a permanent wound for 5 years around her stoma bag hole in the skin. We placed a bag of about 15 grams of modified fluorite close to the stoma hole around the clock. Within approximately one week her wound had healed completely.

Subsequently, she lost the bag with the approximately 15 grams of modified fluorite in it. And within a week, her wound was back again. She was then given another bag with about 15 grams of modified fluorite in it and again within about 1 week her stoma wound healed again.

### Jewelry Products and Their Use

In a still further aspect, the present invention relates to a jewelry product, characterized in that it comprises at least one superconducting material. Preferably, the superconducting material is selected from among fluorite, modified quartz and permanently structured water.

### Use of Modified Fluoride for Jewelry

Modified fluorite can be cut, ground and polished and included in rings, hairbands, bracelets, necklaces, ornaments and in jewelry in general.

### Cleaning Products, Disinfecting Products and Chemical Products and Their Uses

In a further aspect the present invention relates to a cleaning product, disinfecting product and chemical product, characterized in that it comprises at least one superconducting material.

In a still further aspect, the present invention relates to use of superconducting materials for increasing the shelf-life of a product selected from cleaning products.

In a further aspect the present invention relates to use of superconducting materials for increasing the shelf-life of a product selected from disinfecting products.

In a still further aspect, the present invention relates to use of superconducting materials for increasing the shelf-life of a product selected from chemical products.

Because permanently structured water and a superconducting material are able to improve drink products, food products, feeds, blood etc. etc. it is likely that it will also be able to improve cleaning products, disinfecting products and chemical products. The improvement will highly probably be that cleaning products, disinfecting products and chemical products can be diluted with permanently structured water and/or a superconducting material and still have the same efficiency.

### Radioactivity-Reducing Product and Its Use

In a further aspect the present invention relates to a radioactivity-reducing product, characterized in that it comprises at least one superconducting material.

Permanently structured water and a superconducting material are able to improve drink products, food products, feeds, blood, cosmetics, cleaning products, disinfecting products and chemical products by bringing the products back into a highly stable energy state. Therefore, it is likely that via permanently structured water and/or a superconducting material, radioactive substances can be brought into a stable state more quickly than normal.

### Wellness Water Product and Its Use

In a further aspect the present invention relates to a wellness water product, characterized in that it comprises at least one superconducting material.

Permanently structured water and a superconducting material are able to improve the water quality of pools, swimming pools, spas and floating tanks for human beings and animals Water in pools, swimming pools, spas and floating tanks can be fully or partially replaced by permanently structured water and/or superconducting materials can be added into pools, swimming pools, spas and floating tanks.

Humans and animals will experience a better sense of calm and well-being when the water in pools, swimming pools, spas and floating tanks has had superconducting materials added to it. This is because the superconducting materials charge the water with more energy. For a pool with 45,000 litres of water, 1 kg modified fluorite can be placed on the bottom or in the skimmer. People will then feel that there is more energy in the water. This means that there is a greater feeling of calm and well-being than if 1 kg of modified fluorite had not been added to the water.

The water in pools, swimming pools, spas and floating tanks can also be treated with the PSU after which it will become permanently structured water. This means that there is a greater feeling of calm and well-being than if the water had not been treated with the PSU.

### Measuring Methods for Permanently Structured Water

This section describes measurement methods for measuring whether water is permanently structured water. Water that is tested to be permanently structured water according to one or more of the measurement methods described in this section is permanently structured water.

Oxygen Uptake Rate Measurement Method for Permanently Structured Water

Test water is tested for whether it is permanently structured water with the following method.

Test water and regular water are placed in separate vacuum chambers without air until both oxygen percentages are below 10%. Then they are both taken out of the vacuum chamber and both oxygen uptake rates are measured. If the test water has an oxygen uptake rate that is shorter than ordinary water, then boil and condense the test water. The boiled or boiled condensed test water can be left for 72 hours before continuing the test method. Then the boiled or boiled condensed test water is placed again in a vacuum chamber without air until the oxygen percentage in the boiled or boiled condensed test water has an oxygen percentage below 10%. Then the boiled or boiled condensed test water is taken out of the vacuum chamber and the oxygen uptake rate is measured. If the boiled or boiled condensed test water still has an oxygen uptake rate that is shorter than the regular water, the test water is deemed permanently structured water.

Oxygen Release Rate Measurement Method for Permanently Structured Water

Test water is tested for whether it is permanently structured water with the following method.
Test water and regular water are placed in separate vacuum chambers and air is removed until both oxygen percentages are below 10%. The oxygen release rate is measured. If the test water has an oxygen release rate that is shorter than regular water, then boil and condense the test water. The boiled or boiled condensed test water can be left for 72 hours before continuing the test method. Then the boiled or boiled condensed test water is placed again in a vacuum chamber and air is removed until the oxygen percentage is under 10%. If the boiled or boiled condensed test water still has an oxygen release rate that is shorter than the regular water, the test water is deemed permanently structured water.

Infrared Measurement Method for Permanently Structured Water

Test water is tested for whether it is permanently structured water with the following method.
With an infrared camera, a picture is taken of the water surface of an open container with test water and of the water surface of another open container with regular water. The two containers may be separated by a salt barrier If the water surface of test water has a surface temperature that is colder than the water surface with regular water, the test water is boiled, and the water vapor is condensed. The boiled or boiled condensed test water can be left for 72 hours before continuing the test method. Then, with an infrared camera, a picture is taken of the water surface of an open container with the boiled or boiled condensed test water and of the water surface of the open container with regular water. The two containers may be separated by a salt barrier. If the water surface of the boiled or boiled condensed test water has a surface temperature that is still colder than the water surface with regular water, the test water is deemed permanently structured water.

All references, including publications, patent applications and patents, cited herein are hereby incorporated by reference to the same extent as if each reference was individually and specifically indicated to be incorporated by reference and was set forth in its entirety herein.

All headings and sub-headings are used herein for convenience only and should not be construed as limiting the invention in any way.

Any combination of the above-described elements in all possible variations thereof is encompassed by the invention unless otherwise indicated herein or otherwise clearly contradicted by context.

Recitation of ranges of values herein are merely intended to serve as a short method of referring individually to each separate value falling within the range, unless other-wise indicated herein, and each separate value is incorporated into the specification as if it were individually recited herein. Unless otherwise stated, all exact values provided herein are representative of corresponding approximate values (e.g., all exact exemplary values provided with respect to a particular factor or measurement can be considered to also provide a corresponding approximate measurement, modified by “about”, where appropriate).

All methods described herein can be performed in any suitable order unless other-wise indicated herein or otherwise clearly contradicted by context.

The terms “a” and “an” and “the” and similar referents as used in the context of de-scribing the invention are to be construed to insert both the singular and the plural, unless otherwise indicated herein or clearly contradicted by context. Thus, “a” and “an” and “the” may mean at least one, or one or more.

The term “and/or” as used herein is intended to mean both alternatives as well as each of the alternatives individually. For instance, the expression “xxx and/or yyy” means “xxx and yyy”; “xxx”; or “yyy”, all three alternatives are subject to individual embodiments.

The use of any and all examples, or exemplary language (e.g., “such as”) provided herein, is intended merely to better illuminate the invention and does not pose a limitation on the scope of the invention unless otherwise indicated. No language in the specification should be construed as indicating any element is essential to the practice of the invention unless as much is explicitly stated.

The citation and incorporation of patent documents herein is done for convenience only and does not reflect any view of the validity, patentability and/or enforceability of such patent documents.

The description herein of any aspect or embodiment of the invention using terms such as “comprising”, “having”, “including” or “containing” with reference to an element or elements is intended to provide support for a similar aspect or embodiment of the invention that “consists of”, “consists essentially of”, or “substantially comprises” that particular element or elements, unless otherwise stated or clearly contradicted by context (e.g., a composition described herein as comprising a particular element should be understood as also describing a composition consisting of that element, unless otherwise stated or clearly contradicted by context).

This invention includes all modifications and equivalents of the subject matter re-cited in the aspects or claims presented herein to the maximum extent permitted by applicable law.

The features disclosed in the foregoing description may, both separately and in any combination thereof, be material for realizing the invention in diverse forms thereof.

We claim:

1. A method of producing permanently structured water, comprising: passing water through at least one flow form and placing superconducting materials sufficiently close to where the water moves through the flow form.

2. The method according to claim 1, wherein the superconducting material is selected from fluorite, modified quartz, permanently structured water, metals and/or all other conceivable materials that are made superconducting, carbon materials, such as graphite, and crystals.

3. The method according to claim 1, wherein water is passed through at least one flowform that is a shaped like a FIG. 8.

4. A product, comprising: at least one superconducting material, wherein the product is selected from any one of a food product, a cosmetic product, a medicinal product, jewelry product, a cleaning product, a disinfecting product, a chemical product, a radioactivity-reducing product, and a wellness water product.

5. The product of claim 3, further comprising: at least one superconducting material selected from among fluorite, modified quartz and permanently structured water.

6. The product of claim 3, wherein the product is a cosmetic product chosen from among creams, deodorants, and lotions.

7. The product of claim 3, wherein the product is a medicinal product chosen from among blood treatment products, a product that changes the electrical potential of the surface of cells, skin treatment products, and muscle treatment products.

8. Use of superconducting materials for increasing the shelf-life of a product selected from the group consisting of permanently structuring water products, drinks products, food products, feed products, cosmetic products, medical products, jewelry products, cleaning products, disinfecting products, and chemical products.

9. Use according to claim 8, wherein at least one superconducting material is selected from among fluorite, modified quartz and permanently structured water.

10. Use according to claim 8, wherein the product is a drink product.

11. Use according to claim 8, wherein the product is a fruit and/or vegetable.

12. Use according to claim 8, wherein the product is a feed product.

13. Use according to claim 8, wherein the product is a cosmetic and/or medical product.
